(19) United States
(12) Patent Application Publication
(10) Pub. No.: US 2015/0086873 A1
(43) Pub. Date: Mar. 26, 2015

(54) NEGATIVE ELECTRODE FOR NONAQUEOUS ELECTROLYTE SECONDARY BATTERY, NONAQUEOUS ELECTROLYTE SECONDARY BATTERY, AND BATTERY PACK

(71) Applicant: KABUSHIKI KAISHA TOSHIBA, Tokyo (JP)

(72) Inventors: Yasuyuki HOTTA, Tokyo (JP); Takashi KUBOKI, Tokyo (JP); Tomokazu MORITA, Funabashi (JP); Takayuki FUKASAWA, Yokohama (JP); Kenji ESSAKI, Kawasaki (JP); Norikazu OSADA, Tokyo (JP)

(21) Appl. No.: 14/478,125

(22) Filed: Sep. 5, 2014

(30) Foreign Application Priority Data
Sep. 25, 2013 (JP) 2013-197759
Aug. 29, 2014 (JP) 2014-175036

(51) Int. Cl. H01M 4/36; H01M 10/052; H01M 4/70

(52) U.S. Cl. CPC H01M 4/364; H01M 4/70; H01M 10/052; H01M 2220/30
USPC 429/231.8

(57) ABSTRACT

A negative electrode for nonaqueous electrolyte secondary battery of an embodiment includes a current collector, and a negative electrode mixture layer arranged on the current collector. The negative electrode mixture layer includes a negative electrode active material, a conductive material, and a binder. The negative electrode active material is composite particles including a carbonaceous substance, a silicon oxide phase in the carbonaceous substance, and a silicon phase including crystalline silicon in the silicon oxide phase. The negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

### CROSS-REFERENCE TO RELATED APPLICATION

This application is based upon and claims the benefit of priority from Japanese Patent Applications No. 2013-197759, filed on Sep. 25, 2013 and 2014-175036, filed on Aug. 29, 2014; the entire contents of which are incorporated herein by reference.

### FIELD

Embodiments described herein relate to a negative electrode for nonaqueous electrolyte secondary battery, a nonaqueous electrolyte secondary battery, and a battery pack.

### BACKGROUND

In recent years, with rapid development of technologies of downsizing electronics devices, various mobile electronic devices have been spreading. Further, downsizing of batteries that are power sources of the mobile electronic devices is also demanded, and nonaqueous electrolyte secondary batteries having high energy density have drawn attention.

Especially, attempts to use substances having a large lithium storage capacity and high density, such as elements including silicon and tin alloyed with lithium and amorphous chalcogen compounds, as a negative electrode active material have been made. Among them, silicon can store lithium at a ratio up to 4.4 of lithium atoms with respect to one silicon atom, and a negative electrode capacity per mass is about ten times that of graphite carbon. However, silicon has large volume change associated with insertion/detachment of lithium in a charge-discharge cycle, and has a problem in a cycle life, such as pulverization of active material particles.

As a result of diligent experiments, the inventors have found out that, in an active material obtained such that fine silicon monoxide and a carbonaceous substance are compounded and sintered, a negative electrode active material dispersed in the carbonaceous substance is obtained in a state where the fine crystal silicon is contained or held in the silicon oxide firmly coupled with silicon, and when the negative electrode active material is used as a negative electrode for nonaqueous electrolyte secondary battery, a large capacity and improvement of cycle characteristics can be achieved. However, when a charge-discharge cycle is performed hundreds of times in such an active material, binding force between a current collector and an electrode mixture cannot bear volume change, and the capacity is decreased due to separation of the electrode mixture. Thus, life characteristics are insufficient in long term use. When the separation of the electrode mixture due to insufficient binding force is caused as described above, an increase in the binding force by an increase in the amount of a binder can be employed as a measure. However, typically, an insulating resin material is used for the binder, and with an increase in the binder, current collecting properties in the electrode mixture are decreased, and performance deterioration is incurred. Therefore, there is limitation to the increase in the amount of the binder.

### BRIEF DESCRIPTION OF THE DRAWINGS

FIG. 1 is a conceptual diagram of a cross section of a negative electrode according to an embodiment;

FIG. 2 is a SEM image of a negative electrode according to an embodiment;

FIG. 3 is a process flow diagram of a method of manufacturing a negative electrode active material of an embodiment;

FIG. 4 is a conceptual diagram of a nonaqueous electrolyte secondary battery of an embodiment;

FIG. 5 is an enlarged conceptual diagram of a nonaqueous electrolyte secondary battery of an embodiment;

FIG. 6 is a conceptual diagram of a battery pack of an embodiment; and

FIG. 7 is a block diagram illustrating an electrical circuit of a battery pack.

### DETAILED DESCRIPTION

A negative electrode for nonaqueous electrolyte secondary battery of an embodiment includes a current collector, and a negative electrode mixture layer arranged on the current collector. The negative electrode mixture layer includes a negative electrode active material, a conductive material, and a binder. The negative electrode active material is composite particles including a carbonaceous substance, a silicon oxide phase in the carbonaceous substance, and a silicon phase including crystalline silicon in the silicon oxide phase. The negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

A nonaqueous electrolyte secondary battery of an embodiment includes an exterior material, a positive electrode housed in the exterior material, a negative electrode spatially separated from the positive electrode and housed in the exterior material through a separator, and a nonaqueous electrolyte filled in the exterior material. The negative electrode includes a current collector, a negative electrode active material arranged on the current collector, and a negative electrode mixture layer including a conductive material and a binder. The negative electrode active material is composite particles including a carbonaceous substance, a silicon oxide phase in the carbonaceous substance, and a silicon phase including crystalline silicon in the silicon oxide phase. The negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

A battery pack of an embodiment uses a nonaqueous electrolyte secondary battery. The nonaqueous electrolyte secondary battery an exterior material, a positive electrode housed in the exterior material, a negative electrode spatially separated from the positive electrode and housed in the exterior material through a separator, and a nonaqueous electrolyte filled in the exterior material. The negative electrode includes a current collector, a negative electrode active material arranged on the current collector, and a negative electrode mixture layer including a conductive material and a binder. The negative electrode active material is composite particles including a carbonaceous substance, a silicon oxide phase in the carbonaceous substance, and a silicon phase including crystalline silicon in the silicon oxide phase. The negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

Hereinafter, embodiments will be described with reference to the drawings.

### First Embodiment

A nonaqueous electrolyte secondary battery according to a first embodiment includes a current collector, a negative electrode active material arranged on the current collector, and a negative electrode mixture layer including a conductive material and a binder.

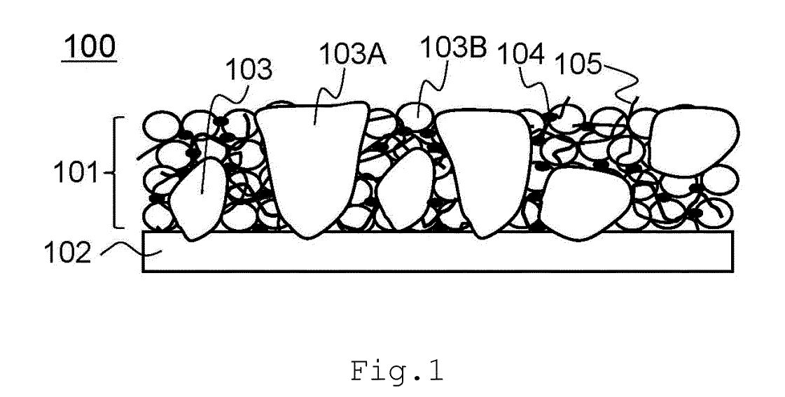

As illustrated in the conceptual diagram of FIG. 1, a negative electrode 100 of the first embodiment includes a negative electrode mixture layer 101 and a current collector 102. The negative electrode mixture layer 101 is a layer of a negative electrode mixture, which is arranged on the current collector 102, and includes a negative electrode active material 103, a conductive material 104, and a binder 105. The binder 105 binds the negative electrode active material 103 and the conductive material 104 that configure the negative electrode 100, and further, loins the negative electrode mixture layer 101 and the current collector 102.

The thickness of the negative electrode mixture layer 101 is desirably from 1 to 150 μm, both inclusive. Therefore, when the negative electrode mixture layers 101 are carried on both surfaces of the negative electrode current collector 102, the total thickness of the negative electrode mixture layer 101 falls within a range from 2.0 to 300 μm, both inclusive. A more favorable range of the thickness of one surface is from 30 to 100 μm, both inclusive. If the thickness falls within this range, large current discharge characteristics and the cycle life is remarkably improved.

Regarding mixing proportions of the negative electrode active material 103, the conductive material 104, and the binder 105 of the negative electrode mixture layer 101, it is favorable that the negative electrode active material 103 falls within a range from 57 to 95 mass % the conductive material 104 fails within a range from 3 to 20 mass-% and the binder 105 falls within a range from 2 to 40 mass-% because favorable large current discharge characteristics and cycle life can be obtained.

The current collector 102 of the embodiment is a conductive member bound with the negative electrode mixture layer 101. As the current collector 102, a conductive substrate having a porous structure or a nonporous conductive substrate can be used. These conductive substrates can be formed of copper, stainless steel, or nickel, for example. The thickness of the current collector is desirably from 5 to 20 μm, both inclusive. If the thickness fails within the range, electrode strength and weight reduction can be balanced.

The negative electrode active material 103 of the embodiment is an active material containing crystalline silicon that performs insertion/detachment of lithium. As a specific example of the negative electrode active material 103 includes composite particles containing a silicon oxide phase in a carbonaceous substance and a silicon phase having crystalline silicon in the silicon oxide phase. The silicon oxide phase of the negative electrode active material of this form is dispersed in the carbonaceous substance, and is compounded with the carbonaceous substance. Further, the silicon phase is dispersed in the silicon oxide phase, and is compounded with the silicon oxide phase.

The negative electrode active material 103 is particles having an average primary particle diameter of from 5 to 100 μm and a specific surface area of from 0.5 to 10 m²/g, both inclusive. The particle diameter of the active material and the specific surface area have influence on a reaction speed of the insertion/detachment of lithium, and have large influence on negative electrode characteristics. However, when the particle diameter and the specific surface area have values within the ranges, the characteristics can be stably exerted.

The silicon phase of the negative electrode active material 103 has large expansion/contraction when storing/releasing lithium, and is favorably micronized and dispersed as much as possible to relax the stress. To be specific, it is favorable that the silicon phase is dispersed with clusters having a size of several nm to 100 nm or less at most.

The silicon oxide phase has an amorphous or a crystalline structure. It is favorable that the silicon oxide phase is bound with the silicon phase and is uniformly dispersed in the active material particles in a form of containing or holding the silicon phase. However, fine crystal silicon held in the silicon oxide is bound with another crystal silicon while storing/releasing lithium and repeating volume change at the time of charging/discharging, and growth of crystallite size advances, resulting in a cause of a decrease in the capacity and the initial charge/discharge efficiency. Therefore, in the present embodiment, the size of the silicon oxide phase is made small and uniform, so that the growth of the crystallite size of the fine crystal silicon is hindered, whereby the capacity deterioration due to the charge-discharge cycle is suppressed, and the life characteristics are improved. A favorable average size of the silicon oxide phase is in a range from 50 to 1000 nm, both inclusive. If the average size exceeds the range, the suppression effect of the size growth of the fine crystal silicon cannot be obtained. Also, when the average size falls below the range, dispersion of the silicon oxide phase in manufacturing of the active material becomes difficult, and problems such as a decrease in rate characteristics and the initial charge/discharge capacity efficiency due to a decrease in the conductivity as an active material are caused. More favorably, the average size is from 100 to 500 nm, exclusive of 500 nm, and if the average size falls within the range, favorable life characteristics can be obtained.

Further, to obtain favorable characteristics of the active material as a whole, the size of the silicon oxide phase is favorably uniform, and a value of (standard deviation/average size) is favorably 1.0 or less with respect to the standard deviation expressed by (d84%−d16%)/2 where 16% accumulation diameter is d16%, and 84% accumulation diameter is d84% in volume integral. Further, when the value is 0.5 or less, excellent life characteristics can be obtained.

Regarding proportions of the silicon phase, the silicon oxide phase, and the carbonaceous substance phase, the molar ratio of total silicon of the silicon phase and the silicon oxide phase and carbon favorably falls within a range of 0.2≦Si/carbon≦2. Regarding a quantitative relationship between silicon of the silicon phase and of the silicon oxide phase, it is favorable that the molar ratio is 0.6≦silicon of the silicon phase/silicon of the silicon oxide phase ≦1.5 because a large capacity and favorable cycle characteristics can be obtained as a negative electrode active material.

A half-value width of a diffraction peak of an Si (220) plane in powder X-ray diffraction measurement of the negative electrode active material 103 is favorably from 1.5° to 8.0°, both inclusive. The diffraction peak half-value width of the Si (220) plane becomes smaller as the crystal grain is grown, and when the crystal grain of the silicon phase is grown in a large way, crack or the like is easily caused in the active material particles with the expansion/contraction associated with the insertion/detachment of lithium. Therefore, if the half-value width falls within a range from 1.5° to 8.0° occurrence of such a problem can be avoided.

The silicon phase performs expansion and contraction with the insertion/detachment of lithium. The silicon phase has a characteristic that the cycle characteristics are easily decreased when the phases are bound and the size of the phase becomes coarse with the expansion/contraction. To prevent the decrease in the cycle characteristics, it is favorable to take measures, such as addition of cubic zirconia, addition of a carbon fiber, and the like, other than the above. It is effective if the diameter of the carbon fiber to be added is similar to the size of the silicon oxide phase, and it is favorable that the average diameter is from 50 to 1000 nm and more favorably, from 100 to 500 nm, both inclusive. The carbon fiber content favorably falls within a range from 0.1 to 8 mass % of the negative electrode active material 103, and is more favorably from 0.5 to 5 mass, both inclusive.

The carbonaceous substance of the negative electrode active material 103 has conductivity, and forms an active material. As the carbonaceous substance, one or more types selected from the group made of graphite, hard carbon, soft carbon, amorphous carbon, and acetylene black can be used. The carbonaceous substance is made of one or more types, and is favorably made of graphite only, or a mixture of graphite and hard carbon. Graphite is favorable in enhancement of the conductivity of the active material, and has large effect to cover the entire hard carbon active material and to relax the expansion/contraction.

The exemplarily illustrated silicon oxide phase relaxes the expansion/contraction of the silicon phase. As the silicon oxide phase, a compound expressed by the chemical formula of SiOₓ (1<x≦2) having an amorphous, low crystalline, or crystalline structure.

The negative electrode active material 103 of the embodiment includes both of an active material particle 103A of composite particles having a large particle diameter and an active material particle 103B that does not have the large particle diameter. d₁ of the negative electrode active material 103A satisfies (d₁/d₀)≦0.9 where the thickness of the negative electrode mixture layer 101 is d₀. Meanwhile, d₁ of the negative electrode active material 103B satisfies (d₁/d₀)<0.9 where the thickness of the negative electrode mixture layer 101 is d₀. d₀ is an average thickness of the negative electrode mixture layer 101.

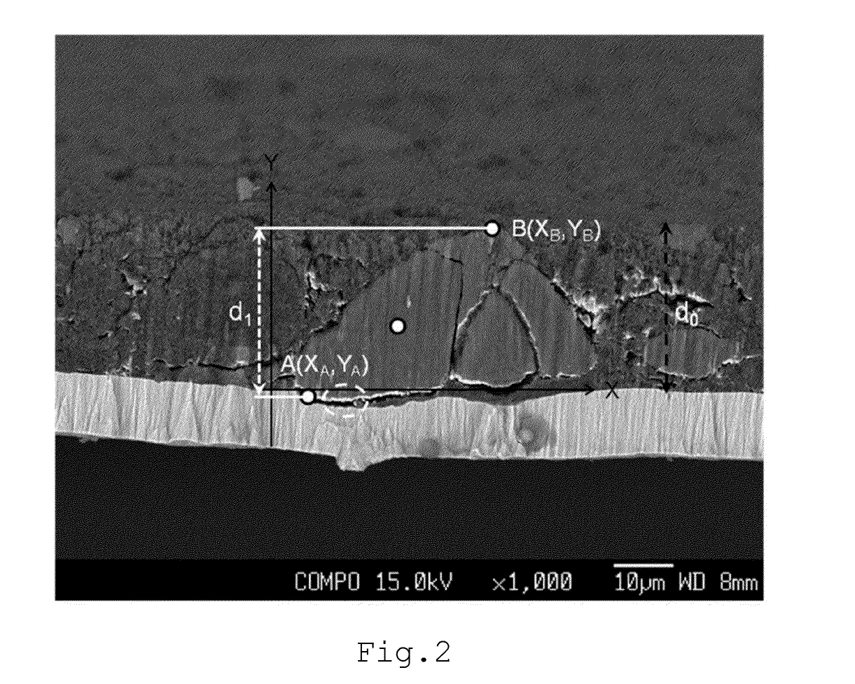

Away of obtaining d₁ that is a maximum thickness of the negative electrode active material 103 in the vertical direction with respect to the current collector 102 surface will be described with reference to a scanning electron microscope (SEM) image of FIG. 2. A surface of the current collector 102 being in contact with the negative electrode mixture layer 101, or a central line of roughness if the surface is a roughened surface is set to an X-axis, and a film thickness direction of the negative electrode mixture layer 101 perpendicular to the X-axis is set to a Y-axis. Next, a point of a particle of the negative electrode active material 103 to be measured closest to the X-axis is A (X_{A}, Y_{A}). Further, a point of a particle of the negative electrode active material 103 to be measured closest to the Y-axis is B (X_{B}, Y_{B}). Then, d₁ can be obtained from d₁=|Y_{A}−Y_{B}|.

The active material particle 103A is a particle with a size, which has been removed with a sieve or the like in a conventional negative electrode, for the purpose of decreasing variation of the characteristics, and the like. In the embodiment, this large active material particle 103A is intentionally included. With the active material particle 103A, adhesive properties between the mixture layer 101 and the current collector 102 can be improved. A mechanism of the improvement of the adhesive properties is considered such that the active material particle 103A restricts the volume change of the active material with the charge/discharge of lithium, so that the volume change that causes separation of the negative electrode mixture layer 101 and the current collector 102 becomes less likely to occur. If d₁ of the active material particle 103A is too large, manufacturing of the negative electrode may become difficult, and mechanical strength of the current collector 102 may be substantially decreased. Therefore, it is favorable that the active material particle 103A satisfies (d₁/d₀)<1.3 in a state where the negative electrode mixture layer 101 is formed.

A part of the active material particle 103A having the large particle diameter is favorably embedded in the current collector 102. When the current collector is recessed to fit the shape of the active material particle 103A as illustrated in a region surrounded by the broken line of FIG. 2 in a range of d₁/20 or more, and from 0.5 to 5 μm the active material particle 103A is embedded in the current collector 102. The current collector being recessed to fit the shape of the active material particle 103A means the shape of a curve of the active material particle 103A at the current collector 102 side and the shape of a recess surface of the current collector 102 approximately accord with each other. When the active material particle 103A is embedded in the current collector 102, the active material particle 103A serves as a stake, and suppresses the volume change amount of the negative electrode mixture layer 101 due to swelling, thereby contributing to the improvement of the cycle characteristics. If the number of the embedded active material particles 103A is too large, the mechanical strength of the current collector 102 may be decreased. Therefore, it is favorable that 10% or less of the active material particles 103A is embedded in the current collector.

It is not favorable that the above effect becomes small if the number of the active material particles 103A is too small. It is not favorable that the negative electrode active material 103 is easily pulverized if the number of the active material particles 103A is too large. Therefore, it is favorable that an area of from 3% to 50% of the negative electrode mixture layer 101 of a cross section of the negative electrode is a particle cross section of the active material particle 103A. It is favorable that the negative electrode cross section satisfies the above condition in all of 9 cross sections obtained by equally dividing the negative electrode into 10 sections in a long side direction. The cross section of the negative electrode can be confirmed with a SEM image enlarged by 1000 times. The sizes of the phases can be seen with the SEM image.

Further, a lithium silicate such as Li₄SiO₄ may be dispersed on the surface or inside the silicon oxide phase. A lithium salt added to the carbonaceous substance performs a solid reaction with the silicon oxide phase inside the composite by thermal processing to form a lithium silicate.

A SiO₂ precursor and a lithium compound may be added in the structure carbonaceous substance that covers the silicon phase and the silicon oxide phase. By adding of these substances to the carbonaceous substance, binding between SiO₂ generated from silicon monoxide and the carbonaceous substance becomes strong, and Li₄SiO₄ having excellent lithium ion conductivity is generated in the silicon oxide phase. An example of the SiO₂ precursor includes alkoxide, such as silicon ethoxide. Examples of the lithium compound include lithium carbonate, lithium oxide, lithium hydroxide, lithium oxalate, or lithium chloride.

The conductive material 104 has effect to enhance the conductivity of the negative electrode, and is favorable to be dispersed and exist in the negative electrode mixture layer 101. Examples of the conductive material 104 include acetylene black, carbon black, and graphite.

The binder 105 of the embodiment is a material excellent in binding properties between the negative electrode active materials, and binging properties between the negative electrode mixture layer 101 and the current collector 102. Examples of the binder 105 include polytetrafluorethylene (PTFE), polyvinylidene fluoride (PVdF), polyacrylic acid, polysaccharide such as alginic acid and cellulose, and its derivatives, ethylene-propylene-diene copolymer (EPDM), styrene-butadiene rubber (SBR), polyimide, and polyaramide. Further, as the binder, a combination of two or more types may be used, and when a combination of a binder excellent in the binding between the active materials and a binder excellent in binding between the active material and the current collector, or a combination of a binder having high hardness and a binder having flexibility is used, a negative electrode excellent in the life characteristics can be produced.

The binder 105 of the embodiment joins the negative electrode mixture layer 101 and the current collector 102. However, a form of Joining the negative electrode mixture layer 101 and the current collector 102 with an azole compound having an amino group as a substituent may be employed.

(Manufacturing Method)

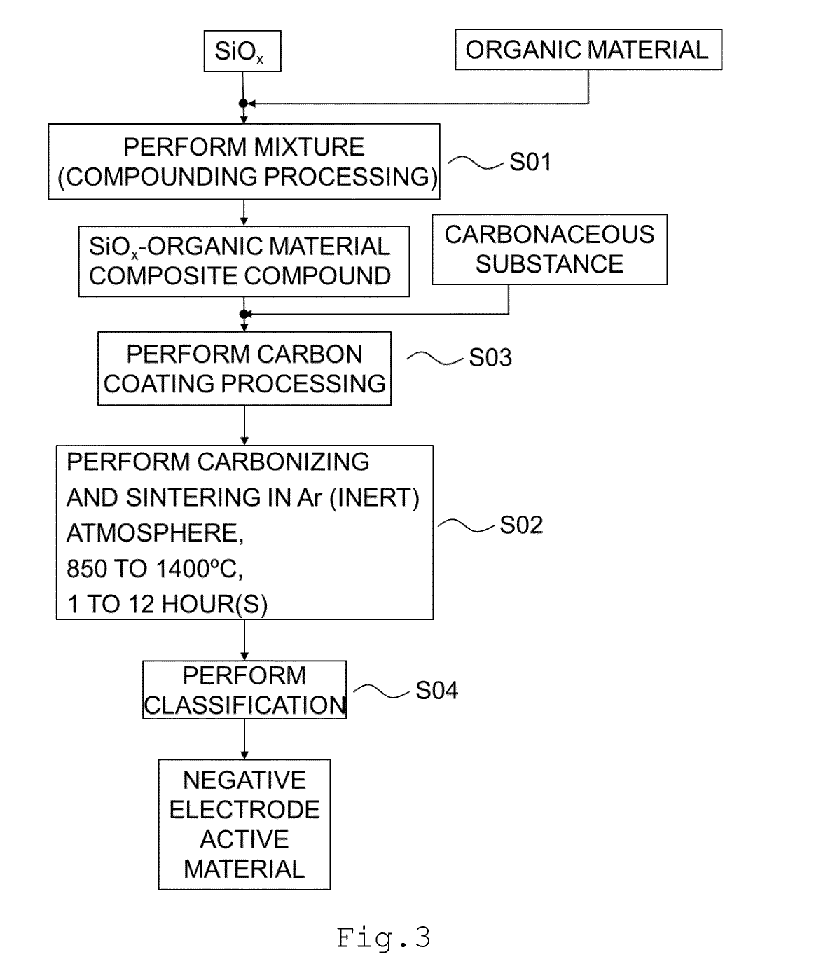

Next, a method of manufacturing the negative electrode 100 of the embodiment will be described. This procedure is illustrated in FIG. 3.

The negative electrode active material according to the embodiment can be synthesized such that ingredients are subjected to dynamic processing in a solid phase or a liquid phase, mixed in stirring processing, and subjected to sintering processing.

(Compounding Processing: S01)

In compounding processing, a silicon-silicon oxide ingredient and an organic material made of graphite and a carbon precursor are mixed to form a composite.

As the silicon-silicon oxide ingredient, it is favorable to use SiO_{X} (0.8≦X≦1.5). Especially, it is desirable to use SiO (X≈1) so that the quantitative relationship between the silicon phase and the silicon oxide phase have a favorable ratio. Further, SiO_{X} may be pulverized at the time of mixture. However, to reduce a processing time and to form the silicon oxide phase having a uniform size, it is favorable to use SiO_{X} in fine powder in advance, and such fine powder can be obtained using a continuous ball mill, a planetary ball mill, or the like. In this case, the primary particle diameter of SiO_{X} is favorably from 50 to 1000 nm on average. Further, it is more favorable to use SiO_{X} having the primary particle diameter of from 100 to 500 nm and having less variation of the particle diameter.

As the organic material, at least one of a carbon material, such as graphite, coke, low-temperature sintered carbon, pitch, and a carbon material precursor can be used. Especially, a material like pitch that is melted by being heated is melted during dynamic mill processing, and compounding does not favorably advance. Therefore, such material is favorably mixed and used with coke or graphite, which is not melted.

Examples of the dynamic compounding processing include a turbo mill, a ball mill, a mechano-fusion, and a disk mill.

An operation condition of the dynamic compounding processing varies depending on devices. However, it is favorable to perform the processing until the pulverization/compounding sufficiently advances. However, if an output is raised too much or the time is spent too much in compounding, silicon and carbon react with each other, and inert silicon carbide is generated to an insertion reaction of lithium. Therefore, it is necessary to determine an appropriate condition, with which the pulverization/compounding sufficiently advances and the silicon carbide is not generated.

A method of performing compounding by mixture and stirring in a liquid phase will be described below. The mixture/stirring processing can be performed by various stirring devices, a ball mill, a bead mill device, or a combination thereof. For the compounding of silicon monoxide having fine particles and the carbon precursor, and the carbon material, it is favorable to perform liquid phase mixture in a liquid using a dispersion medium. This is because it is difficult for a dry mixture means to uniformly disperse the ingredients without agglomerating the silicon monoxide having fine particles and the carbon precursor. As the dispersion medium, an organic solvent, water, or the like can be used. It is favorable to use a liquid having affinity for both of the silicon monoxide and the carbon precursor, and the carbon material. Specific examples include ethanol, acetone, isopropyl alcohol, methyl ethyl ketone, and ethyl acetate. Further, the carbon precursor is favorably soluble to a liquid or the dispersion medium at the mixture stage so as to be uniformly mixed with the silicon monoxide having fine particles, and is especially favorably a monomer or an oligomer that is a liquid and is easily polymerizable. Examples include organic materials that form a furan resin, a xylene resin, a keton resin, an amino resin, a melamine resin, a urea resin, an aniline resin, an urethane resin, a polyimide resin, a polyester resin, an epoxy resin, and a phenol resin. The materials mixed in the liquid phase forms a SiO_{X}-organic material composite compound through a solidifying or drying process.

(Carbonizing and Sintering Processing: S02)

Carbonizing and sintering is performed in an inert atmosphere, such as in Ar. In the carbonizing and sintering, a polymer or a carbon precursor such as pitch in the SiO_{X}-organic material composite compound is carbonized, and SiO_{X} is separated into two phases of the silicon phase and the silicon oxide phase by generation of a crystal of silicon by a disproportionation reaction. The reaction is expressed by the following formula (1) where X=1.

2SiO→Si+SiO₂ (1)

This disproportionation reaction advances at a higher temperature than 800° C., and SiO_{X} is separated into the fine silicon phase and the silicon oxide phase. As the reaction temperature is raised, a crystal of the silicon phase becomes larger, and a half-value width of a peak of the Si (220) becomes smaller. A sintering temperature at which the half-value width in a favorable range can be obtained is within a range from 850 to 1600° C., both inclusive. Further, the crystalline silicon generated by the disproportionation reaction reacts with carbon at a temperature higher than 1400° C., and is changed into silicon carbide. Silicon carbide is completely inert with respect to insertion of lithium, and thus, when silicon carbide is generated, the capacity of the active material is decreased. Therefore, the temperature of the carbonizing and sintering is favorably from 850 to 1400° C. and more favorably from 900 to 1100° C., both inclusive. The sintering time is favorably about between 1 and 12 hour(s).

(Carbonizing and Coating Processing: S03)

As a next process, carbon coating may be performed with respect to the particles obtained by the compounding processing. As a material used for coating, a material that becomes a carbonaceous substance by being heated in an inert atmosphere, such as pitch, a resin, or a polymer, can be used. To be specific, a material that can be well carbonized at about 1200° C. sintering, such as petroleum pitch, mesophase pitch, a furan resin, cellulose, or rubber. This is because, as described in the sintering processing section, the sintering cannot be performed at a temperature higher than 1400° C. A coating method is to polymerize and solidify the composite particles in a state of being dispersed in a monomer and to carbonize and sinter an obtained product. Alternatively, a polymer is dissolved in a solvent, the composite particles are dispersed, the solvent is then transpired, and the obtained solid body is carbonized and sintered. Further, as another method used for carbon coating, carbon coating with chemical vapor deposition (CVD) can be performed. This is a method to cause a gas carbon source to flow on a sample heated to from 800 to 1000° C. using an inert gas as a carrier gas, and to perform carbonization on the surface of the sample. In this case, as the carbon source, benzene, toluene, styrene, or the like can be used. Further, when the carbon coating by the CVD is performed, the sample is heated to from 800 to 1000° C. and thus the carbon coating may be simultaneously performed with the carbonizing and sintering.

A lithium compound and an SiO₂ source may be simultaneously added at the time of the carbon coating.

(Classification: S04)

The particle diameter, the specific surface area, and the like of the product after the carbonizing and sintering are prepared using various mills, a pulverizing device, a grinder, or the like. After the preparation, classification is performed using a sieve, whereby the negative electrode active material 103 having a favorably particle diameter is obtained. A sieve mesh size may just be appropriately adjusted based on the thickness d₀ of the negative electrode mixture layer 101. A favorable sieve mesh size is from 0.9d₀ to 1.0d₀, both inclusive. When the particle diameter is adjusted, it is favorable to perform the adjustment such that particles having a diameter of the sieve mesh size or more are included. When the ratio of the active material particles 103A and 103B is adjusted, first, a sieve having the sieve mesh size of from 0.9d₀ to 1.0d₀ is used, and particles under the sieve are collected. Next, the particles are classified using a sieve having the sieve mesh size of about 0.7d₀. As a result, the active material particle 103B is obtained under the sieve and the active material particle 103A is obtained over the sieve. By adjusting of the mixing ratio of the both particles, the ratio of the particles that satisfy (d₁/d₀)≧0.9 and the particles that do not satisfy (d₁/d₀)≧0.9 of the negative electrode active material 103 can be adjusted.

According to the above-described manufacturing method, the negative electrode active material according to the present embodiment can be obtained.

Next, the negative electrode active material 103, the conductive material 104, and the binder 105 are suspended in a general-purpose solvent, and slurry is prepared. The slurry is applied to the current collector 102, dried, and applied a press, so that the negative electrode 100 is produced. With pressure of the press, embedding of the negative electrode active material 103 to the current collector 102 can be adjusted. A press with pressure lower than 0.2 kN is not favorable because embedding is not much caused. If the press is performed with pressure higher than 10 kN, damage, such as cracking of the negative electrode active material 103 or the current collector 102, is caused, and thus it is not favorable. Therefore, the press pressure given to the layer on which the slurry is dried is favorably from 0.5 to 5 kN, both inclusive.

### Second Embodiment

A nonaqueous electrolyte secondary battery according to a second embodiment will be described.

A nonaqueous electrolyte secondary battery according to the second embodiment includes an exterior material, a positive electrode housed in the exterior material, a negative electrode including an active material and spatially separated from the positive electrode and housed in the exterior material, through a separator, for example, and a nonaqueous electrolyte filled in the exterior material.

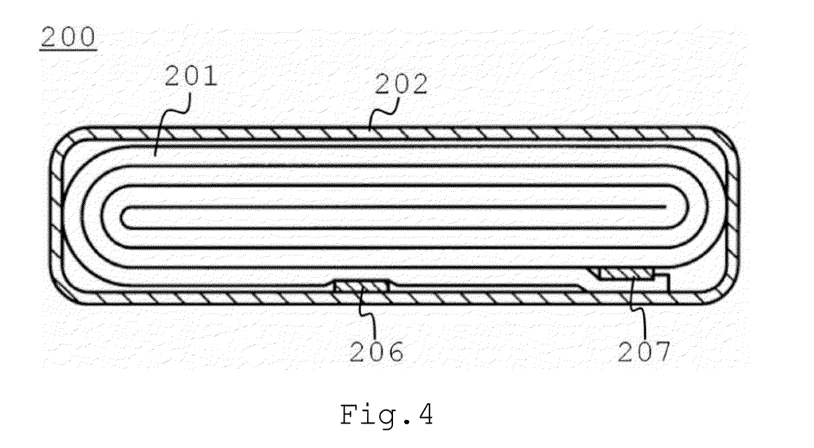

An example of a nonaqueous electrolyte secondary battery 200 according to the embodiment will be described in more detail with reference to the conceptual diagram of FIG. 4. FIG. 4 is a conceptual diagram of a cross section of the flat nonaqueous electrolyte secondary battery 200 having a bag-like exterior material 202 made of a laminated film.

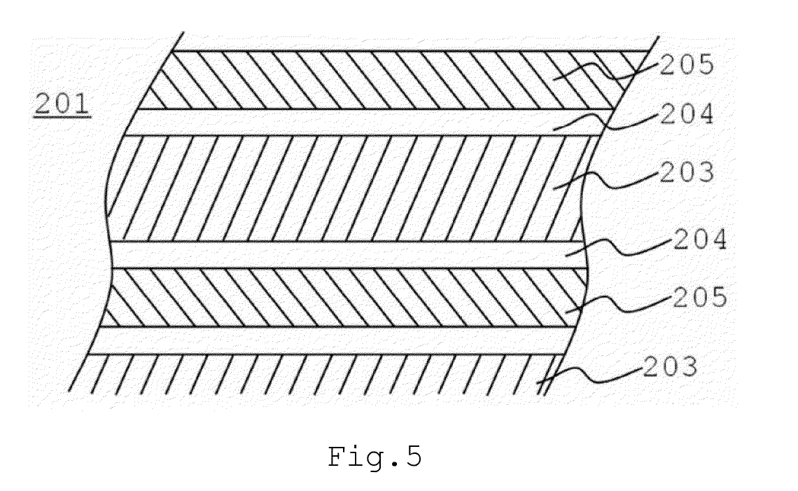

A flat wound electrode group 201 is housed in the exterior material 202 made of a laminated film that interposes an aluminum foil between two resin layers. The flat wound electrode group 201 is laminated in the order of a negative electrode 203, a separator 204, a positive electrode 205, and a separator 204, as illustrated in FIG. 5 that is a conceptual diagram extracting a part of the flat wound electrode group. Then, the flat wound electrode group 201 is formed such that a laminated product is wound in a spiral manner and is press molded. An electrode closest to the exterior material 202 is the negative electrode 203, and the negative electrode 203 has a structure in which a negative electrode mixture layer is not formed on the negative electrode current collector of the exterior material 202 side, and the negative electrode mixture layer is formed only on one surface of the negative electrode current collector of an inner surface side of the battery. Other negative electrodes 203 are configured such that the negative electrode mixture layers are formed on both sides of the negative electrode current collector. The positive electrode 205 is configured such that the positive electrode mixture layers are formed on both sides of the positive electrode current collector.

In the vicinity of an outer peripheral end of the wound electrode group 201, a negative electrode terminal is electrically connected to the negative electrode current collector of the outermost negative electrode 203, and a positive electrode terminal is electrically connected to the positive electrode current collector of the inner-side positive electrode 205. These negative electrode terminal 206 and positive electrode terminal 207 extend outside through an opening of the exterior material 202. For example, a liquid nonaqueous electrolyte is injected through the opening of the exterior material 202. The opening of the exterior material 202 is heat-sealed while sandwiching the negative electrode terminal 206 and the positive electrode terminal 207, so that the wound electrode group 201 and the liquid nonaqueous electrolyte are sealed.

In the embodiment, the wound electrode group 201 has been described as an electrode group. However, a laminated type electrode group having a structure in which positive electrodes and negative electrodes are alternately laminated while interposing a separator in between can be used. The wound electrode group can more favorably obtain the effect of the present embodiment.

An example of the negative electrode terminal 206 includes an aluminum alloy containing elements such as Al, Mg, Ti, Zn, Mn, Fe, Cu, and Si. To reduce contact resistance with the negative electrode current collector, the material of the negative electrode terminal 206 is favorably similar to that of the negative electrode current collector.

As the positive electrode terminal 207, a material having electrical stability and conductivity in a range of a potential to the lithium ion metal being 3 to 4.25 V can be used. To be specific, an aluminum alloy containing elements such as Al, Mg, Ti, Zn, Mn, Fe, Cu, and Si can be used. To reduce the contact resistance with the positive electrode current collector, the material of the positive electrode terminal 207 is favorably similar to that of the positive electrode current collector.

Hereinafter, the bag-like exterior material 202, the positive electrode 205, the electrolyte, and the separator 204 that are configuration members of the nonaqueous electrolyte secondary battery 200 will be described in detail.

1) Exterior Material 202

The exterior material 202 is formed of a laminated film having the thickness of 0.5 mm or less. Alternatively, as the exterior material, a metal container having the thickness of 1.0 mm or less is used. The metal container favorably has the thickness of 0.5 mm or less.

The shape of the exterior material 202 can be selected from a flat type (thin type), a square type, a cylindrical type, a coin type, and a button type. Examples of the exterior material include a small battery exterior material mounted on mobile electronic devices and the like, and a large battery exterior material mounted on two-wheeled to four-wheeled automobiles and the like, according to dimensions of the battery.

As the laminated film, a multilayer film interposing a metal layer between resin layers is used. The metal layer is favorably an aluminum foil or an aluminum alloy foil for weight reduction. As the resin layer, a polymeric material, such as polypropylene (PP), polyethylene (PE), nylon, or polyethylene terephthalate (PET), can be used, for example. The laminated film can be formed into the shape of the exterior material by sealing with heat seal.

The metal container is made of aluminum or an aluminum alloy. The aluminum alloy is favorably an alloy containing elements, such as magnesium, zinc, and silicon. When a transition metal, such as iron, copper, nickel, or chromium, is contained in the alloy, an amount of the transition metal is favorably 100 mass ppm or less.

2) Positive Electrode 205

The positive electrode 205 has a structure in which the positive electrode mixture layer including an active material is carried on one or both surfaces of the positive electrode current collector.

The thickness of the one surface of the positive electrode mixture layer is favorably in a range from 1.0 to 150 μm because of retention of the large current discharge characteristics and the cycle life of the battery. Therefore, when the positive electrode mixture layers are carried on the both surfaces of the positive electrode current collector, the total thickness of the positive electrode mixture layers favorably falls within a range from 20 to 300 μm, both inclusive. A more favorable range of the one surface is from 30 to 120 μm, both inclusive. If the thickness falls within this range, the large current discharge characteristics and the cycle life are improved.

The positive electrode mixture may include a conductive material in addition to the positive electrode active material and the binder that binds the positive electrode active materials.

As the positive electrode active material, various oxides, such as a manganese dioxide, a lithium-manganese composite oxide, a nickel cobalt oxide containing lithium (for example, LiCOO₂), a nickel cobalt oxide containing lithium (for example, LiNi_{0.8}CO_{0.2}O₂), a lithium-manganese composite oxide (for example, LiMn₂O₄, LiMnO₂), can be used because a high voltage can be obtained.

Examples of the conductive material include acetylene black, carbon black, and graphite.

Specific examples of the binder, polytetrafluorethylene (PTFE), polyvinylidene fluoride (PVdF), ethylene-propylene-diene copolymer (EPDM), or styrene-butadiene rubber (SER) can be used, for example.

Regarding the mixing proportions of the positive electrode active material, the conductive material, and the binder, it is favorable that the positive electrode active material falls within a range from 80 to 95 mass % the conductive material falls within a range from 3 to 20 mass % and the binder falls within a range from 2 to 7 mass % because favorable large current discharge characteristics and cycle life can be obtained.

As the current collector, a conductive substrate having a porous structure or nonporous conductive substrate can be used. The thickness of the current collector is desirably from 5 to 20 μm, both inclusive. This is because, if the thickness falls within the range, electrode strength and weight reduction can be balanced.

The positive electrode 205 is produced such that the active material, the conductive material, and the binder are suspended in a general-purpose solvent to prepare slurry, and this slurry is applied to the current collector, dried, and applied a press. Alternatively, the positive electrode 205 may be produced such that the active material, the conductive material, and the binder are formed into a pellet to form the positive electrode layer, and this layer is formed on the current collector.

3) Negative Electrode 203

As the negative electrode 203, the negative electrode 100 described in the first embodiment is used.

4) Electrolyte

As the electrolyte, a nonaqueous electrolyte solution, an electrolyte impregnated polymer electrolyte, a polymeric electrolyte, or an inorganic solid electrolyte can be used.

The nonaqueous electrolyte solution is a liquid electrolyte solution prepared such that an electrolyte is dissolved in a nonaqueous solvent, and is held in gaps in the electrode group.

As the nonaqueous solvent, it is favorable to use a nonaqueous solvent mainly including a mixture solvent of propylene carbonate (PC), ethylene carbonate (EC), and a nonaqueous solvent (hereinafter, referred to as second solvent) having lower viscosity than PC and EC.

As the second solvent, chain carbon is favorable, for example. Examples of chain carbon include dimethyl carbonate (DMC), methylethyl carbonate (MEC), diethyl carbonate (DEC), ethyl propionate, methyl propionate, γ-butyrolactone (BL), acetonitrile (AN), ethyl acetate (EA), toluene, xylene, and methyl acetate (MA). These second solvents may be used alone or in a form of a mixture of two or more types of the solvents. Especially, the second solvent favorably has the donner number of 16.5 or less.

The viscosity of the second solvent is favorably 2.8 cmp or less at 25° C. The mixing amount of ethylene carbonate or propylene carbonate in the mixture solvent is favorably 1.0% to 80% in volume ratio. Amore favorable mixing amount of the ethylene carbonate or propylene carbonate is 20% to 75% in volume ratio.

Examples of the electrolyte contained in the nonaqueous electrolyte solution include lithium salts (electrolytes), such as lithium perchlorate (LiClO₄), lithium hexafluorophosphate (LiPF₆), lithium tetrafluoroborate (LiBF₄), lithium hexafluoro arsenate (LiAsF₆), lithium trifluoromethanesulfonate (LiCF₃SO₃), and lithium bis(trifluoromethanesulfonimide) [LiN(CF₃SO₂)₂]. Among them, it is favorable to use LiPF₆ or LiBF₄.

A dissolving amount of the electrolyte to the nonaqueous solvent is desirably from 0.5 to 2.0 mol/L, both inclusive.

5) Separator 204

When the nonaqueous electrolyte solution is used, and when the electrolyte impregnated polymer electrolyte is used, the separator 204 can be used. As the separator 204, porous separator is used. As a material of the separator 204, for example, a porous film containing polyethylene, polypropylene, or polyvinylidene difluoride (PVdF), a non-woven fabric made of a synthetic resin, or the like can be used. Among them, a porous film made of polyethylene or polypropylene, or both of them is favorable because safety of the second battery can be improved.

The thickness of the separator 204 is favorably 30 μm or less. If the thickness exceeds 30 μm, the distance between the positive and negative electrodes becomes large, and internal resistance may become large. Further, a lower limit of the thickness is favorably 5 μm. If the thickness is less than 5 μm, the strength of the separator 204 is significantly decreased, and internal short circuit may be easily caused. An upper limit of the thickness is favorably 25 μm, and the lower limit is favorably 1 μm.

The separator 204 favorably has thermal shrinkage of 20% or less when the separator 204 is left for one hour in a condition of 120° C. When the thermal shrinkage exceeds 20%, a possibility of occurrence of short circuit due to heating becomes large. The thermal shrinkage is favorably 15% or less.

Porosity of the separator 204 is favorably in a range of 30% to 70%. This is because of the following reasons. If the porosity is less than 30%, it may become difficult to obtain high electrolyte retention in the separator 204. Meanwhile, if the porosity exceeds 70%, sufficient strength of the separator 204 may not be obtained. More favorable range of the porosity is 35% to 70%.

The separator 204 favorably has air permeability of 500 seconds/100 cm³ or less. If the air permeability exceeds 500 seconds/100 cm³, it becomes difficult for separator 204 to obtain high lithium ion mobility. Further, a lower limit of the air permeability is 30 seconds/100 cm³. If the air permeability is less than 30 seconds/100 cm³, sufficient separator strength may not be obtained.

An upper limit of the air permeability is favorably 300 seconds/100 cm³, and the lower limit is more favorably 50 seconds/100 cm³′

### Third Embodiment

Next, a battery pack according to a third embodiment will be described.

A battery pack according to the third embodiment includes one or more nonaqueous electrolyte secondary battery (that is, single batteries) according to the second embodiment. The single batteries are used as cells of the battery pack. When the battery pack includes a plurality of single batteries, the single batteries are electrically connected and arranged in series, in parallel, or in series and in parallel.

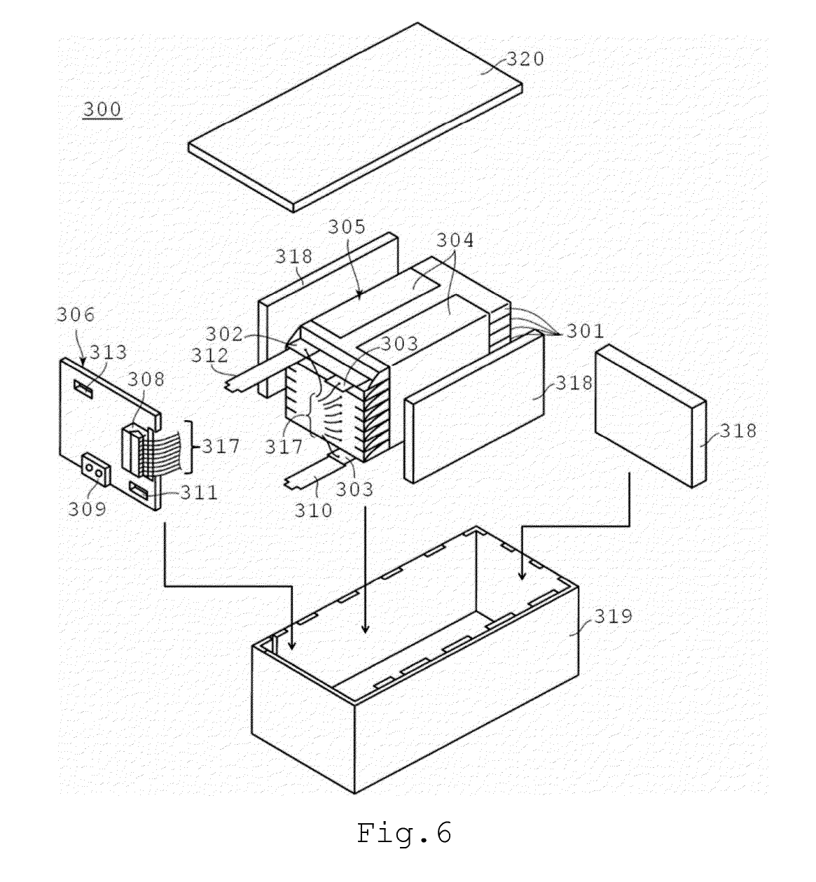

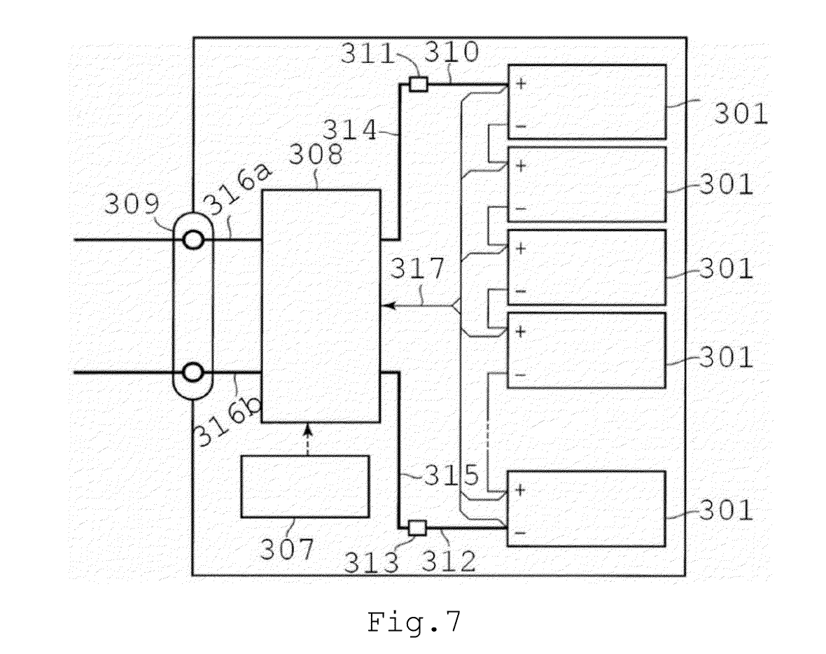

A battery pack 300 will be described in detail with reference to the conceptual diagram of FIG. 6 and the block diagram of FIG. 7. In the battery pack 300 illustrated in FIG. 6, a flat nonaqueous electrolyte solution battery 200 illustrated in FIG. 6 is used as a single battery 301.

The plurality of single batteries 301 configures an assembled battery 305 such that a negative electrode terminal 302 and a positive electrode terminal 303 extending outside are layered to be arranged in the same direction, and are fastened with an adhesive tape 304. These single batteries 301 are electrically connected with each other in series, as illustrated in FIG. 7.

A print circuit board 306 is arranged facing a side surface of the single batteries 301 into which the negative electrode terminal 302 and the positive electrode terminal 303 extend. On the print circuit board 306, as illustrated in FIG. 7, a thermistor 307, a protection circuit 308, and a current carrying terminal 309 to an external device are mounted. Note that an insulating plate (not illustrated) is attached to a surface of the print circuit board 306 facing the assembled battery 305 in order to avoid unnecessary connection with wiring of the assembled battery 305.

A positive electrode-side lead 310 is connected to the positive electrode terminal 303 positioned at a lowermost layer of the assembled battery 305, and its tip is inserted into and electrically connected to a positive electrode-side connector 311 of the print circuit board 306. A negative electrode-side lead 312 is connected to the negative electrode terminal 302 positioned at an uppermost layer of the assembled battery 305, and its tip is inserted into and electrically connected to a negative electrode-side connector 313 of the print circuit board 306. These connectors 311 and 313 are connected to the protection circuit 308 through wiring 314 and 315 formed on the print circuit board 306.

The thermistor 307 is used for detecting the temperature of the single battery 301, and its detection signal is transmitted to the protection circuit 308. The protection circuit 308 can cut off plus-side wiring 316a and minus-side wiring 316b between the protection circuit 308 and the current carrying terminal 309 to an external device in a predetermined condition. The predetermined condition is, for example, a time when a detection temperature of the thermistor 307 becomes a predetermined temperature or more. Further, the predetermined condition is a time when overcharge, over discharge, overcurrent, or the like of the single battery 301 is detected. This detection of overcharge or the like is performed in individual single battery 301 or in the single batteries 301 as a whole. When an individual single battery 301 is detected, a battery voltage may be detected, or a positive electrode potential or a negative electrode potential may be detected. In the latter case, a lithium electrode used as a reference electrode is inserted into individual batteries 301. In the case of FIGS. 6 and 7, wiring 317 for detecting a voltage is connected to each of the single batteries 301, and a detection signal is transmitted to the protection circuit 308 through these pieces of wiring 317.

Protection sheets 318 made of rubber or a resin are arranged on three surfaces of the assembled battery 305 excluding a side surface through which the positive electrode terminal 303 and the negative electrode terminal 302 protrude, respectively.

The assembled battery 305 is housed in a housing container 319 together with the protection sheets 318 and the print circuit board 306. That is, the protection sheets 318 are arranged on both inner surfaces of the housing container 319 in a long side direction and on an inner surface in a short side direction, and the print circuit board 306 is arranged on an opposite-side inner surface in the short side direction. The assembled battery 305 is positioned in a space surrounded by the protection sheets 318 and the print circuit board 306. A lid 320 is attached on an upper surface of the housing container 319.

Note that, for fixation of the assembled battery 305, a thermal shrinkable tape may be used instead of the adhesive tape 304. In this case, protection sheets are arranged on both side surfaces of the assembled battery, a thermal shrinkable tape is wound and is then thermally shrunk, and the assembled battery is fixed.

While FIGS. 6 and 7 illustrate a form in which the single batteries 301 are connected in series. However, to increase the battery capacity, the single batteries may be connected in parallel, or series connection and parallel connection may be combined. The assembled battery packs may be further connected in series or in parallel.

According to the present embodiment, with the nonaqueous electrolyte secondary battery having excellent charge-discharge cycle performance in the third embodiment, a battery pack having excellent charge-discharge cycle performance can be provided.

Note that the form of the battery pack is appropriately changed according to its use. Use of the battery pack that exerts the excellent cycle characteristics when a large current is taken out is favorable. To be specific, examples of the use include a battery pack for digital camera power source, and on-vehicle battery packs for two-wheeled to four-wheeled hybrid electric automobile, for two-wheeled to four-wheeled electric automobile, and for assist bicycle. Especially, a battery pack using a nonaqueous electrolyte secondary battery having excellent high temperature characteristics is favorably used as an on-vehicle battery pack.

Hereinafter, specific examples will be given, and its effects will be described.

### Example 1

Pulverization of SiO, kneading, formation of a composite, and sintering in an Ar gas were performed in the following conditions, and a negative electrode active material was obtained.

Pulverization of SiC was performed as follows. Pulverization processing was performed for a predetermined time with respect to ingredient SiO powder in a continuous bead mill device, using beads having a bead diameter of 0.5 mm and ethanol as a dispersion medium. Further, pulverization of the SiC powder was performed with a planetary ball mill, using balls of 0.1 mm and ethanol as a dispersion medium, and SiC fine powder was produced.

Silicon monoxide powder obtained by fine pulverization processing and graphite powder of 6 μm were compounded with hard carbon by the following method. 2.8 g of SiO powder, 0.7 g of graphite powder, 0.06 g of carbon filer having an average diameter of 180 nm were added to mixed liquor of 4.0 g of furfuryl alcohol, 10 g of ethanol, and 0.125 g of water, and the mixed liquid was subjected to kneading processing with a kneading device, and was made into slurry. 0.2 g of a dilute hydrochloric acid that serves as a polymerization catalyst of the furfuryl alcohol was added to the kneaded slurry, left at room temperature, dried, and solidified, and a carbon composite was obtained.

The obtained carbon composite was sintered in an Ar gas at 1050° C. for 3 hours, cooled to the room temperature, and then pulverized and sieved with a sieve having a diameter of 75 μm. A negative electrode active material was obtained under the sieve.

15 mass % of graphite having an average diameter of 6 μm, 3.5 mass % of an SBR resin, and 5 mass % of carboxymethyl cellulose were kneaded with the obtained negative electrode active material using water as a dispersion medium, and were applied on a copper foil having the thickness of 12 μm with a gap of 80 atm, dried at 100° C. for 2 hours, and rolled with 2.0 kN. A sample cut into a predetermined size was vacuum-dried at 100° C. for 12 hours, and was used as a test electrode.

(Charge/Discharge Test)

A part of a cross section of the produced electrode was taken out, and d₁/d₀ and an embedded depth of the active material were measured by SEM observation. A battery in which a counter electrode and a reference electrode were metal Li, and an electrolyte solution was an EC/DEC (volume ratio EC:DEC=1:2) solution of LiPF₆ (1M) was produced in an Ar atmosphere, and charge/discharge test was performed. A condition of the charge/discharge test was such that charging was performed with current density of 1 mA/cm² until a potential difference between the reference electrode and the test electrode became 0.01 V, and constant voltage charging was performed with 0.01 V for 16 hours. Discharging was performed with the current density of 1 mA/cm² until 1.5 V. Further, a cycle of charging with the current density of 1 mA/cm² until the potential difference between the reference electrode and the test electrode became 0.01 V, and discharging with the current density of 1 mA/cm² until 1.5 V was performed 100 times, and a maintenance percentage of the discharge capacity of the 100th cycle to the first cycle was measured.

### Example 2

Similar materials to Example 1 were used except that rolling pressure after application of electrode slurry was 0.3 kN, and similar evaluation was performed.

### Example 3

Similar evaluation to Example 1 was performed except that 15 mass % of graphite having an average diameter of 6 μm, and 8 mass % of polyimide were kneaded with an obtained negative electrode active material sample using N-methylpyrrolidone as a dispersion medium, applied on a copper foil having the thickness of 12 μm with a gap of 80 μm, rolled with 2.0 kN, and then subjected to thermal processing in an Ar gas at 250° C. for 2 hours. The sample was cut into a predetermined size, vacuum dried at 100° C. for 12 hours, and was used as a sample electrode.

### Example 4

Similar materials to Example 1 were used and similar evaluation was performed except that obtained carbon composite powder was sieved with a sieve having a diameter of 53 μm, and a negative electrode active material was obtained under the sieve.

### Example 5

Similar materials to Example 1 were used except that rolling pressure after application of electrode slurry was 0.2 kN, and similar evaluation was performed.

### Comparative Example 1

Similar materials to Example 1 were used and similar evaluation was performed except that a carbon composite sintered at 1050° C. for 3 hours in an Ar atmosphere in Example 1 was pulverized, and classified with a sieve of 20 μm.

### Comparative Example 2

Similar materials to Example 2 were used and similar evaluation was performed except that a carbon composite sintered at 1050° C. for 3 hours in an Ar atmosphere in Example 1 was pulverized, and classified with a sieve of 20 μm.

### Comparative Example 3

Similar materials to Example 1 were used and similar evaluation was performed except that rolling pressure after application of electrode slurry using a composite similar to Comparative Example 1 was 8.0 kN.

Table 1 was made regarding Examples and Comparative Examples.

TABLE 1

| | d₁/ | d₁/ | | Thick- | Discharge | Maintenance |
|---|---|---|---|---|---|---|
| | d₀ ≧ | d₀ < | Depth | ness | capacity | Capacity |
| | 0.9 | 0.9 | [μm] | [μm] | [mAh/g] | [%] |
| Example 1 | 0.93 | 0.35 | 2.1 | 33 | 874 | 93 |
| Example 2 | 0.95 | 0.41 | 0.4 | 38 | 876 | 90 |
| Example 3 | 0.93 | 0.41 | 2.5 | 30 | 881 | 96 |
| Example 4 | 0.90 | 0.40 | 1.1 | 30 | 871 | 85 |
| Example 5 | 0.98 | 0.41 | 0.3 | 40 | 869 | 82 |
| Comparative | nil | 0.41 | 1.6 | 34 | 830 | 61 |
| Example 1 | | | | | | |
| Comparative | nil | 0.40 | 0.2 | 37 | 685 | 57 |
| Example 2 | | | | | | |
| Comparative | nil | 0.41 | 5.8 | 26 | 828 | 51 |
| Example 3 | | | | | | |

d₁/d₀ ≧ 0.9: Average d₁/d₀ of active material particles having d₁/d₀ of 0.9 or more
d₁/d₀ < 0.9: Average d₁/d₀ of active material particles having d₁/d₀ of less than 0.9
Depth: Embedded depth [μm]
Thickness: Thickness of negative electrode mixture layer [μm]
Maintenance Capacity: Capacity maintenance percentage after 100 cycles [%]

From the results in Table 1, it can be understood that the negative electrode of the present embodiment has a large discharge capacity and favorable cycle characteristics. That is, in Comparative Example 1, separation was caused between the electrode mixture and the current collector as the charge/discharge advances, and thus the cycle characteristics were decreased. Further, the cycle characteristics of Examples 1 and 3 are more excellent than that of Example 2. This can be considered that, in the electrodes in Examples 1 and 2, the cycle characteristics were improved because the negative electrode active materials were embedded in the current collectors.

In the specification, a part of elements is expressed by element symbols.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A negative electrode for nonaqueous electrolyte secondary battery, the negative electrode comprising:
a current collector; and
a negative electrode mixture layer arranged on the current collector, and including a negative electrode active material, a conductive material, and a binder, wherein
the negative electrode active material is composite particles including a carbonaceous substance, a silicon oxide phase in the carbonaceous substance, and a silicon phase including crystalline silicon in the silicon oxide phase, and
the negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

2. The negative electrode according to claim 1, wherein the negative electrode active material that satisfies d₁/d₀≧0.9 occupies an area of from 3% to 50% of a cross section of the mixture layer.

3. The negative electrode according to claim 1, wherein a part of the negative electrode active material that satisfies d₁/d₀≧0.9 is embedded in the current collector with a depth of from 0.5 to 5 μm, exclusive of 5 μm.

4. The negative electrode according to claim 1, wherein 10% of the negative electrode active material that satisfies d₁/d₀≧0.9 is embedded in the current collector.

5. A nonaqueous electrolyte secondary battery comprising:
an exterior material;
a positive electrode housed in the exterior material;
a negative electrode spatially separated from the positive electrode and housed in the exterior material through a separator; and
a nonaqueous electrolyte filled in the exterior material, wherein
the negative electrode includes a current collector, a negative electrode active material arranged on the current collector, and a negative electrode mixture layer including a conductive material and a binder,
the negative electrode active material is composite particles including a carbonaceous substance, a silicon oxide phase in the carbonaceous substance, and a silicon phase including crystalline silicon in the silicon oxide phase, and
the negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

6. The battery according to claim 5, wherein the negative electrode active material that satisfies d₁/d₀≧0.9 occupies an area of from 3% to 50% of a cross section of the mixture layer.

7. The battery according to claim 5, wherein a part of the negative electrode active material that satisfies d₁/d₀≧0.9 is embedded in the current collector with a depth of from 0.5 to 5 μm, exclusive of 5 μm.

8. The battery according to claim 5, wherein 10% of the negative electrode active material that satisfies d₁/d₀≧0.9 is embedded in the current collector.

9. A battery pack using a nonaqueous electrolyte secondary battery, the nonaqueous electrolyte secondary battery comprising:
an exterior material;
a positive electrode housed in the exterior material;
a negative electrode including an active material, and spatially separated from the positive electrode and housed in the exterior material through a separator; and
a nonaqueous electrolyte filled in the exterior material, wherein
the negative electrode includes a current collector, a negative electrode active material arranged on the current collector, and a negative electrode mixture layer including a conductive material and a binder,
the negative electrode active material is composite particles including a carbonaceous substance, a silicon oxide phase in the carbonaceous substance, and a silicon phase including crystalline silicon in the silicon oxide phase, and
the negative electrode active material satisfies d₁/d₀≧0.9 where an average thickness of the mixture layer is d₀, and a maximum thickness of a single particle of the composite particles in a vertical direction, the particle occupying the mixture layer, to a surface of the current collector is d₁.

10. The battery pack according to claim 9, wherein the negative electrode active material that satisfies d₁/d₀≧0.9 occupies an area of from 3 to 50% of a cross section of the mixture layer.

11. The battery pack according to claim 9, wherein a part of the negative electrode active material that satisfies d₁/d₀≧0.9 is embedded in the current collector with a depth of from 0.5 to 5 μm, exclusive of 5 μm.

12. The battery pack according to claim 9, wherein 10% of the negative electrode active material that satisfies d₁/d₀≧0.9 is embedded in the current collector.
